(19) United States
(12) Patent Application Publication
(10) Pub. No.: US 2013/0173692 A1
(43) Pub. Date: Jul. 4, 2013

(54) APPARATUS AND METHOD FOR REMINDING USER OF OVERLONG ACCESS TO WEBPAGE

(71) Applicants: RONG-RONG PENG, Shenzhen City (CN); YAO-HUA LIU, Shenzhen City (CN); XIN LU, Shenzhen City (CN); SHIH-FANG WONG, Tu-Cheng (TW)

(72) Inventors: RONG-RONG PENG, Shenzhen City (CN); YAO-HUA LIU, Shenzhen City (CN); XIN LU, Shenzhen City (CN); SHIH-FANG WONG, Tu-Cheng (TW)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/457,515

(22) Filed: Apr. 27, 2012

(30) Foreign Application Priority Data
Dec. 28, 2011 (CN) 201110446527.3

(51) Int. Cl. G06F 15/16

(52) U.S. Cl. 709/203

(57) ABSTRACT

An apparatus for reminding a user of overlong access to a webpage is provided. The apparatus typically includes a communicating module, a timing module, and a control module. The communicating module transmits to a network server a request by the user to be logged into the network server, and accesses a webpage of the network server. The timing module times an elapse time of the webpage being not operated by the user. The control module sends a reminder to the user to operate the webpage when the elapse time has reached a reminding time. The control module stores information which was edited on the webpage and webpage content if the webpage is not operated again within a predetermined period, and transmit a signal containing an instruction for the network server to log out the user. A related method is also provided.

### BACKGROUND

1. Technical Field

The present disclosure relates to an apparatus and a method for reminding a user with access to a webpage that his/her access is overlong.

2. Description of the Related Art

In some servers, only a login user is permitted to do some operations, such as editing data on a webpage. Typically, after the user's operation on the webpage is first received, the server enables a timer to begin to time the user's access of the webpage. If no operation on the webpage is received within a predetermined time period, the server automatically cancels the login status of the user, and does not receive any more inputted data from the user. When this happens, the already edited data on the webpage is lost, and the user needs to login the server again to access the webpage and input the lost data again. This wastes time and is inconvenient.

### BRIEF DESCRIPTION OF THE DRAWINGS

The emphasis is placed upon clearly illustrating the principles of the disclosure.

FIG. 1 is a block diagram of an apparatus for reminding a user of overlong access to a webpage, in accordance with an exemplary embodiment.

FIG. 2 is a flowchart illustrating a method for reminding a user of overlong access to a webpage, in accordance with an exemplary embodiment.

### DETAILED DESCRIPTION

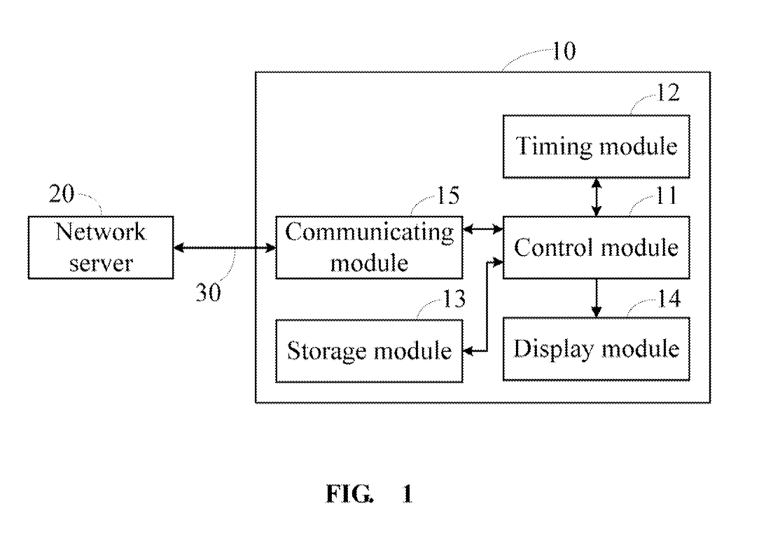

FIG. 1 is a block diagram of an apparatus for reminding a user of overlong access to a webpage. The apparatus 10 communicates with a network server 20 via a network 30. In the embodiment, the apparatus 10 is incorporated in a personal computer, and the network 30 can for example be the Internet, an intranet, a Local Area Network, an Ethernet, etc. The apparatus 10 includes a control module 11, a timing module 12, a storage module 13, a display module 14, and a communicating module 15.

The timing module 12 has a preset reminder time stored therein. In the embodiment, the timing module 12 can change the reminder time according to a preference of the user input by the user to the apparatus 10. The control module 11 controls the communicating module 15 to transmit to the network server 20 a request by the user of the apparatus 10 to be logged in the network server 20, and accesses (for example) a webpage of the network server 20 via the communicating module 15 when the network server 20 logs in the user. The timing module 12 times (i.e., tracks) an elapsed time of the webpage not being operated by the user, and determines whether the elapsed time has reached the reminder time. When the elapsed time is determined to have reached the reminder time, the timing module 12 generates a signal and transmits the signal to the control module 11. In response to the signal provided by the timing module 12, the control module 11 sends a reminder to the user, reminding the user to operate the webpage.

The control module 11 then determines whether the webpage is subsequently operated again by the user within a predetermined period. If the webpage is not operated again within the predetermined period, the control module 11 stores in the storage module 13 information which has been edited on the webpage and webpage content which is displayed on the display module 14, and generates a signal and transmits the signal to the network server 20. The network server 20 logs out the user in response to the signal provided by the control module 11, and thereby the apparatus 10 can no longer access the webpage of the network server 20 via the communicating module 15. If the webpage is operated again within the predetermined period, the timing module 12 recommences timing an elapsed time of the webpage not being operated by the user.

In the embodiment, the control module 11 further displays the elapsed time detected by the timing module 12 on the display module 14, to enable the user to monitor his/her own inaction in relation to the network server 20. In a further embodiment, the timing module 12 also generates a sound signal to remind the user when the elapsed time is determined to have reached the reminder time. The sound signal can be preset by the user on the apparatus 10.

Once the user is logged out, the control module 11 determines the intention of the user as to accessing the webpage again or not. In the embodiment, this determination is made according to an attempted operation by the user on the webpage or the absence of any such attempt. If the user shows his/her intention to access the webpage again by attempting to operate the webpage, the control module 11 automatically transmits via the communicating module 15 a request to the network server 20 for the user to be logged into the network server 20, and obtains from the storage module 13 the information which was edited on the webpage and the webpage content which was displayed on the display module 14. Then, the control module 11 controls the display module 14 to display the obtained webpage content and the obtained information which was edited on the webpage for the user to continue to access the webpage. In the embodiment, after the user is logged out, and when the control module 11 detects any attempted operation on the webpage, the control module 11 displays a user interface, prompting the user to select whether to access the webpage again or not. If the user selects “yes,” the control module 11 submits the request for the user to be logged into the network server 20 to the network server 20 via the communicating module 15.

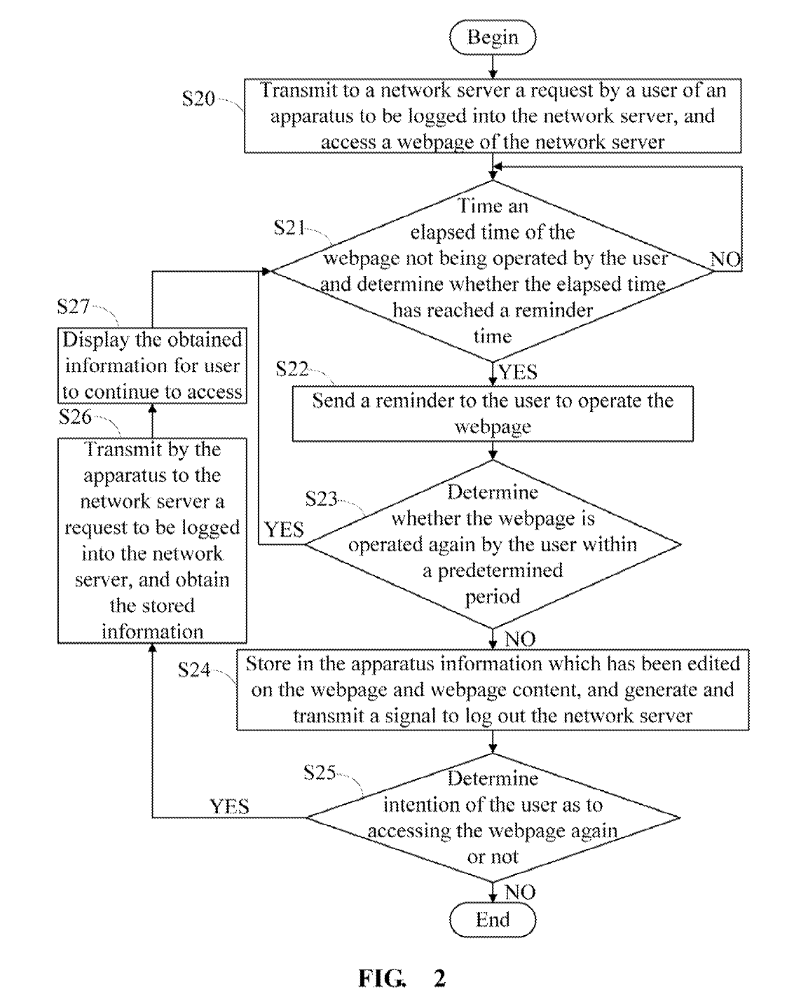

FIG. 2 is a flowchart illustrating a method for reminding a user of overlong access to a webpage.

In step S20, the control module 11 controls the communicating module 15 to transmit to the network server 20 via the communicating module 15 a request by a user of the apparatus 10 to be logged into the network server 20, and accesses (for example) a webpage of the network server 20 via the communicating module 15 when the network server 20 logs in the user.

In step S21, the timing module 12 times an elapsed time of the webpage not being operated by the user, and determines whether the elapsed time has reached the reminder time. If the determination is yes, the procedure goes to step S22; otherwise, the procedure returns to step S21.

The timing module 12 has a preset reminder time stored therein. In the embodiment, the timing module 12 can change the reminder time according to a preference of the user input by the user to the apparatus 10.

In step S22, the timing module 12 generates a signal and transmits the signal to the control module 11. The control module 11 sends a reminder to the user in response to the signal provided by the timing module 12, reminding the user to operate the webpage.

In the embodiment, the control module 11 displays the elapsed time detected by the timing module 12 on the display module 14, to enable the user to monitor his/her own inaction in relation to the network server 20. In a further embodiment, the timing module 12 also generates a sound signal to remind the user when the elapsed time is determined to have reached the reminder time. The sound signal can be preset by the user on the apparatus 10.

In step S23, the control module 11 determines whether the webpage is subsequently operated again by the user with a predetermined period. If the determination is no, the procedure goes to step S24; otherwise, the procedure returns to step S21.

In step S24, the control module 11 stores in the storage module 13 information which has been edited on the webpage and webpage content which is displayed on the display module 14, and generates a signal and transmits the signal to the network server 20. The network server 20 logs out the user in response to the signal provided by the control module 11.

In step S25, the control module 11 determines the intention of the user as to accessing the webpage again or not. If the determination is yes, the procedure goes to step S26; otherwise, the procedure ends.

In the embodiment, the determination is made according to an attempted operation by the user on the webpage or the absence of any such attempt. In particular, when the control module 11 detects any attempted operation on the webpage, the control module 11 displays a user interface, prompting the user to select whether to access the webpage again or not. If the user selects “yes,” the procedure goes to step S26; otherwise, the procedure ends.

In step S26, the control module 11 automatically transmits via the communicating module 15 a request to the network server 20 for the user to be logged into the network server 20, and obtains from the storage module 13 the information which was edited on the webpage and the webpage content which was displayed on the display module 14. Thereupon, the procedure goes to step S27.

In step S27, the control module 11 controls the display module 14 to display the obtained webpage content and the obtained information which was edited on the webpage for user to continue to access the webpage. Thereupon, the procedure returns to step S21.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An apparatus for reminding a user of overlong access to a webpage, the apparatus comprising:
a storage module;
a communicating module configured for communicating with a network server, for transmitting to the network server a request by a user of the apparatus to be logged into the network server, and for accessing a webpage of the network server;
a timing module configured for storing a preset reminder time, for timing an elapsed time of the webpage not being operated by the user, and for determining whether the elapsed time has reached the reminding time; and
a control module configured for:
sending a reminder to the user to remind the user to operate the webpage when the elapsed time is determined by the timing module to have reached the reminding time;
determining whether the webpage is operated again by the user within a predetermined period after the reminder is sent; and
if the webpage is determined to be not operated again within the predetermined period, storing in the storage module information which was edited on the webpage and webpage content and generating a signal and transmitting the signal to the network server, wherein the signal contains an instruction for the network server to log out the user.

2. The apparatus as recited in claim 1, wherein the control module is further configured for:
determining an intention of the user as to accessing the webpage again if the network server logs out the user, the determination made according to whether the user attempts to operate the webpage again;
transmitting via the communicating module a request to the network server for the user to be logged into the network server if it is determined that the user intends to access the webpage again;
obtaining from the storage module the information which was edited on the webpage and the webpage content which was accessed; and
controlling an associated display to display the obtained webpage content and the obtained information which was edited on the webpage for the user to continue to access the webpage.

3. The apparatus as recited in claim 2, further comprising a display module configured for, under control of the control module, displaying a user interface to prompt the user to select whether to access the webpage again or not when the control module determines the intention of the user as to accessing the webpage again.

4. The apparatus as recited in claim 3, wherein the display module is further configured for displaying the elapsed time detected by the timing module to enable the user to monitor his/her own inaction in relation to the network server.

5. The apparatus as recited in claim 1, wherein the reminder time stored by the timing module is changeable according to a preference of the user input by the user to the apparatus.

6. The apparatus as recited in claim 1, wherein the timing module is further configured for recommencing timing an elapsed time of the webpage not being operated by the user, if the webpage is determined by the control module to be operated again within the predetermined period.

7. The apparatus as recited in claim 1, wherein the timing module is further configured for generating a sound signal to remind the user to operate the webpage when the elapsed time is determined to have reached the reminder time.

8. A method for reminding a user of an apparatus of overlong access to a webpage, the method comprising:
storing a reminder time in the apparatus;
transmitting to a network server communicatively coupled to the apparatus a request by the user to be logged into the network server, and accessing a webpage of the network server;
timing an elapsed time of the webpage not being operated by the user, and determining whether the elapsed time has reached the reminder time;
sending a reminder to the user to remind the user to operate the webpage if the elapsed time is determined to have reached the reminder time;
determining whether the webpage is operated again by the user with a predetermined period after the reminder is sent; and
if the webpage is determined to be not operated within the predetermined period, storing in the apparatus information which has been edited on the webpage and the webpage content, and transmitting a signal to the network server, wherein the signal contains an instruction for the network server to log out the user.

9. The method as recited in claim 8, further comprising:
determining an intention of the user as to accessing the webpage again if the user is logged out by the network server; and
transmitting to the network server a request by the user to be logged into the network server and obtaining the information and the webpage content stored in the apparatus and returning to timing an elapsed time of the webpage not being operated by the user and determining whether the elapsed time has reached the reminder time, if it is determined that the user intends to access the webpage again.

10. The method as recited in claim 9, wherein determining an intention of the user as to accessing the webpage again comprises the apparatus displaying a user interface to prompt the user to select whether to access the webpage again.

11. The method as recited in claim 8, further comprising displaying the elapsed time on the apparatus to enable the user to monitor his/her own inaction in relation to the network server.

12. The method as recited in claim 8, further comprising returning to timing an elapsed time of the webpage not being operated by the user and determining whether the elapsed time has reached the reminder time, if it is determined that the webpage is operated again within the predetermined period.

13. The method as recited in claim 8, further comprising changing the reminder time stored in the apparatus according to a preference of the user input by the user to the apparatus.

14. The method as recited in claim 8, further comprising the apparatus generating a sound signal to remind the user to operate the webpage if the elapsed time is determined to have reached the reminder time.

15. An apparatus for reminding a user of overlong access to a webpage, the apparatus comprising:
a communicating module configured for communicating with a network server, for transmitting to the network server a request by a user of the apparatus to be logged into the network server, and for accessing a webpage of the network server;
a timing module configured for storing a preset reminder time, for timing an elapsed time of the webpage not being operated by the user, and for determining whether the elapsed time has reached the reminding time;
a storage module; and
a control module configured for:
determining whether the webpage is operated again by the user within a predetermined period after the elapsed time is determined to have reached the reminding time; and
if the webpage is determined to be not operated again within the predetermined period, storing in the storage module information which was edited on the webpage and the webpage content and generating a signal and transmitting the signal to the network server, wherein the signal contains an instruction for the network server to log out the user.

16. The apparatus as recited in claim 15, wherein the control module is further configured for sending a reminder to the user to remind the user to operate the webpage when the elapsed time is determined by the timing module to have reached the reminding time.

17. The apparatus as recited in claim 16, wherein the timing module is further configured for generating a sound signal to remind the user to operate the webpage when the elapsed time is determined to have reached the reminder time.

18. The apparatus as recited in claim 16, further comprising a display module configured for displaying the elapsed time detected by the timing module to enable the user to monitor his/her own inaction in relation to the network server.

19. The apparatus as recited in claim 16, wherein the control module is further configured for:
determining an intention of the user as to accessing the webpage again if the network server logs out the user, the determination made according to whether the user attempts to operate the webpage again;
transmitting via the communicating module a request to the network server for the user to be logged into the network server if it is determined that the user intends to access the webpage again;
obtaining from the storage module the information which was edited on the webpage and the webpage content which was accessed; and
controlling an associated display to display the obtained webpage content and the obtained information which was edited on the webpage for the user to continue to access the webpage.

20. The apparatus as recited in claim 15, wherein the reminder time stored by the timing module is changeable according to a preference of the user input by the user to the apparatus.
